(19) United States
(12) Patent Application Publication
(10) Pub. No.: US 2025/0296679 A1
(43) Pub. Date: Sep. 25, 2025

(54) AIRCRAFT LIFT ENHANCEMENT SYSTEM

(71) Applicants: Richard HEALY, Hermosa Beach, CA (US); Farhan GANDHI, Albany, NY (US); Rensselaer Polytechnic Institute, Troy, NY (US)

(72) Inventors: Richard Healy, Hermosa Beach, CA (US); Farhan Gandhi, Albany, NY (US)

(73) Assignee: Rensselaer Polytechnic Institute, Troy, NY (US)

(21) Appl. No.: 18/863,379

(22) PCT Filed: May 8, 2023
(86) PCT No.: PCT/US2023/021315

§ 371 Date: Nov. 6, 2024

Related U.S. Application Data
(60) Provisional application No. 63/339,102, filed on May 6, 2022.

(51) Int. Cl. B64C 27/22; B64C 29/00

(52) U.S. Cl. CPC B64C 27/22; B64C 29/0025

(57) ABSTRACT

An aircraft lift enhancement system is provided. The aircraft lift enhancement system includes an airfoil and at least one rotor. The airfoil includes a leading edge and a trailing edge defining a longitudinal axis of the airfoil, and a proximal end and a distal end defining a length of the airfoil. The at least one rotor is positioned a first distance substantially behind the trailing edge of the airfoil as measured along the longitudinal axis and a second distance substantially vertically below a lower surface of the airfoil. The at least one rotor includes a hub and a plurality of aerodynamic blades extending outwards from the hub a radial distance R and configured to rotate in a substantially horizontal plane around a center point of the rotor.

### CROSS REFERENCE TO RELATED APPLICATIONS

This application claims the priority benefit of U.S. Provisional Patent Application No. 63/339,102, filed May 6, 2022, which is incorporated by reference as if disclosed herein in its entirety.

### FIELD

The present technology relates generally to the field of aircrafts, and more particularly, to rotor-wing systems for vertical take-off and landing (“VTOL”) aircrafts.

### BACKGROUND

In recent years there has been a significant interest in using large multi-rotor electric vertical take-off and landing (“eVTOL”) aircraft for Urban Air Mobility. One of the challenges associated with the modeling, simulation and performance prediction of these aircraft is the complex interactional aerodynamic flow fields of multiple rotors operating in close proximity. One beneficial configuration is the rotor-blown wing which has been shown to increase lift by using the rotor wake to increase dynamic pressure over the airfoil and potentially keep flow attached at high wing angles of attack.

In the context of propeller driven aircraft, the slipstream of a propeller will augment the lift and drag of downstream wings, and the presence of the wings can lead to propeller thrust fluctuations and increased propeller thrust. Further wing lift increases may be obtained when the rotor is mounted above the wings. Certain eVTOL aircraft may take advantage of this effect during wing-borne cruise, but during low-speed flight, propellers will not be the only source of aerodynamic interaction.

During hover and low-speed flight, many eVTOL designs supplement lift with vertically thrusting rotors that are fixed to the wings. In these configurations, aerodynamic interactions between these lifting rotors and the wing can be expected to negatively influence overall system performance. Similar interactions occur on tiltrotor platforms, where rotor downwash on a tiltrotor's wing induces flow separation and reduces wing lift. Additionally, lifting rotors mounted in front of and above a wing also degrade wing lift due to rotor-wing aerodynamic interaction in forward flight.

What is needed, therefore, is an improved rotor-wing system that addresses at least the problems described above.

### SUMMARY

According to an embodiment of the present technology, an aircraft lift enhancement system is provided. The aircraft lift enhancement system includes an airfoil and at least one rotor. The airfoil includes a leading edge and a trailing edge defining a longitudinal axis of the airfoil, and a proximal end and a distal end defining a length of the airfoil. The at least one rotor is positioned a first distance D1 substantially behind the trailing edge of the airfoil as measured along the longitudinal axis and a second distance D2 substantially vertically below a lower surface of the airfoil. The at least one rotor includes a hub and a plurality of aerodynamic blades extending outwards from the hub a radial distance R and configured to rotate in a substantially horizontal plane around a center point CP of the rotor.

In some embodiments, the first distance D1 and the second distance D2 are measured relative to a quarter chord point CH of the airfoil, the quarter chord point CH is positioned on a chord measured between the leading edge and the trailing edge.

In some embodiments, the first distance D1 is about 2 times the radial distance R.

In some embodiments, the second distance D2 is about 0.7 times the radial distance R.

In some embodiments, the first distance D1 is such that the positioning of the at least one rotor results in a longitudinal overlap of the trailing edge of the airfoil and the at least one rotor of less than 0.125 times the radial distance R.

In some embodiments, the at least one rotor includes a plurality of rotors positioned the first distance D1 and the second distance D2 from the airfoil and adjacent one another along the length of the airfoil.

In some embodiments, each of the plurality of rotors is separated from each respective adjacent rotor by a blade-tip to blade-tip spacing of about 0.25 times the radial distance R.

In some embodiments, the airfoil has an asymmetrical shape.

In some embodiments, the at least one rotor is driven by an electric motor.

In some embodiments, the at least one rotor is driven by a wet fuel engine.

In some embodiments, the proximal end of the airfoil is connected to a fuselage of an aircraft.

In some embodiments, the at least one rotor is connected to the airfoil via a mounting bracket.

In some embodiments, the at least one rotor is connected to the fuselage via a support frame.

According to another embodiment of the present technology, an aircraft is provided. The aircraft includes a fuselage having a front end and a tail end defining a longitudinal axis of the aircraft, a first lateral side, and a second lateral side opposite the first lateral side; a first airfoil having a first leading edge and a first trailing edge substantially aligned with the longitudinal axis of the aircraft, and a first proximal end and a first distal end defining a length of the airfoil, the first proximal end is connected to the first lateral side of the fuselage; a second airfoil having a second leading edge and a second trailing edge substantially aligned with the longitudinal axis of the aircraft, and a second proximal end and a second distal end defining a length of the airfoil, the second proximal end is connected to the second lateral side of the fuselage; at least one first rotor positioned a first distance D1 substantially behind the first trailing edge of the first airfoil as measured along the longitudinal axis and a second distance D2 substantially vertically below a first lower surface of the first airfoil; and at least one second rotor positioned the first distance D1 substantially behind the second trailing edge of the second airfoil as measured along the longitudinal axis and the second distance D2 substantially vertically below a second lower surface of the second airfoil. Each of the at least one first rotor and the at least one second rotor include a hub and a plurality of aerodynamic blades extending outwards from the hub a radial distance R and configured to rotate in a substantially horizontal plane around a center point CP of the rotor.

In some embodiments, the first distance D1 and the second distance D2 are measured relative to a first quarter chord point CH1 of the first airfoil and a second quarter chord point CH2 of the second airfoil, the first quarter chord point CH1 is positioned on a chord measured between the first leading edge and the first trailing edge, and the second quarter chord point CH2 is positioned on a chord measured between the second leading edge and the second trailing edge.

In some embodiments, the first distance D1 is about 2 times the radial distance R.

In some embodiments, the second distance D2 is about 0.7 times the radial distance R.

In some embodiments, the first distance D1 is such that the positioning of each of the at least one first rotor and at least one second rotor results in a longitudinal overlap of the trailing edge of the respective airfoil and the respective rotor of less than 0.125 times the radial distance R.

In some embodiments, the at least one first rotor includes a plurality of first rotors positioned the first distance D1 and the second distance D2 from the first airfoil and adjacent one another along the length of the first airfoil, and the at least one second rotor includes a plurality of second rotors positioned the first distance D1 and the second distance D2 from the second airfoil and adjacent one another along the length of the second airfoil.

In some embodiments, each of the plurality of first rotors and the plurality of second rotors is separated from each respective adjacent rotor by a blade-tip to blade-tip spacing of about 0.25 times the radial distance R.

In some embodiments, each of the first airfoil and the second airfoil has an asymmetrical shape.

In some embodiments, each of the at least one first rotor and the at least one second rotor is driven by a respective electric motor.

In some embodiments, each of the at least one first rotor and the at least one second rotor is driven by a respective wet fuel engine.

In some embodiments, the at least one first rotor is connected to the first airfoil via a first mounting bracket and the at least one second rotor is connected to the second airfoil via a second mounting bracket.

In some embodiments, the at least one first rotor is connected to the fuselage via a first support frame and the at least one second rotor is connected to the fuselage via a second support frame.

In some embodiments, a propeller is connected to the front end of the fuselage, and the propeller is driven by a wet fuel engine.

Further objects, aspects, features, and embodiments of the present technology will be apparent from the drawing Figures and below description.

### BRIEF DESCRIPTION OF DRAWINGS

Some embodiments of the present technology are illustrated as an example and are not limited by the figures of the accompanying drawings, in which like references may indicate similar elements.

FIG. 1 is a top perspective view of an aircraft lift enhancement system according to an embodiment of the present technology.

FIG. 2 is a side elevational view of the aircraft lift enhancement system of FIG. 1.

FIG. 3 is a top plan view of an aircraft having an aircraft lift enhancement system according to an embodiment of the present technology.

### DETAILED DESCRIPTION

Accordingly, exemplary embodiments of the present technology are directed to an aircraft lift enhancement system having a lifting rotor mounted below and behind the wing of an aircraft, which results in additional suction over the upper surface of the wing. The rotor-induced suction over the upper surface of the wing increases wing lift by up to 134%, and this phenomenon increases at higher values of rotor disk loading. As the rotor disk loading increases, the rotor induced suction over the upper surface of the wing also increases, thereby increasing the wing lift coefficient by about 0.13 for each additional pound-per-square-foot (lb/ft²) of disk loading. The inventors have surprisingly discovered that this added suction near the leading edge of the wing counters the nominal wing drag and introduces a net propulsive force, which increases at higher wing incidence angles and higher rotor disk loading. In some embodiments, the wing-induced downwash on the rotor introduces a thrust deficit of up to 10% and a torque penalty of up to 4% from nominal. Despite these rotor performance penalties, the increased wing lift and reduced wing drag resulting from the rotor-induced suction increases the lift-to-drag ratio by up to 49% as compared to the wing without the rotor interactions.

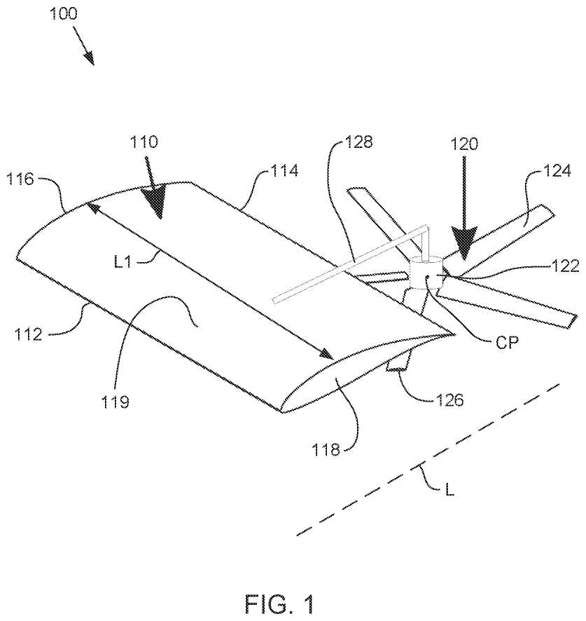

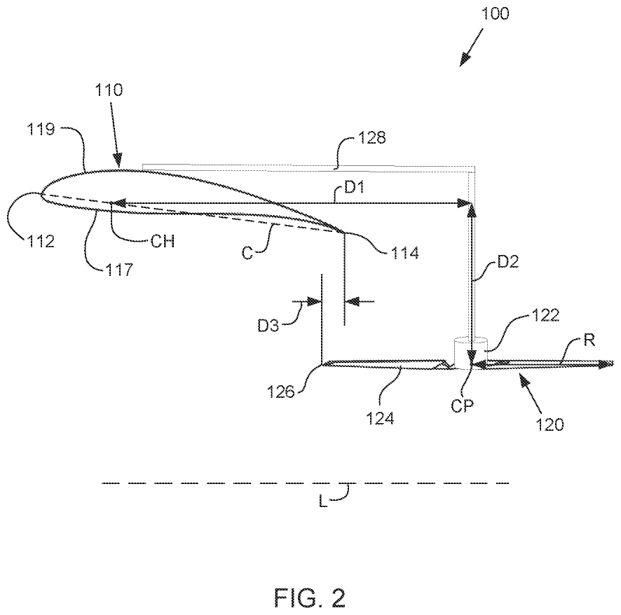

As shown in FIG. 1, an aircraft lift enhancement system is generally designated by the numeral 100. The system 100 includes an airfoil 110 and at least one rotor 120. The airfoil 110 includes a leading edge 112 and a trailing edge 114 that generally define a longitudinal axis L of the system 100. The airfoil 110 includes a proximal end 116 and a distal end 118 that define the length L1 of the airfoil 110. The length L1 of the airfoil 110 is substantially perpendicular to the longitudinal axis L. In some embodiments, the airfoil 110 is a wing of an aircraft, such as a VTOL or an eVTOL aircraft. In some embodiments, the airfoil 110 has an asymmetrical shape, as shown in FIGS. 1-2.

The rotor 120 includes a hub 122 and a plurality of blades 124 connected to and extending outward from the hub 122. Each blade 124 extends outward from the hub 122 a radial distance R and is configured to rotate in a substantially horizontal plane around the center point CP of the rotor 120, as shown in FIG. 2. The blades 124 have an aerodynamic shape and configuration such that rotation of the blades 124 generates lift. In some embodiments, the hub 122 rotates with the blades 124. In some embodiments, the hub 122 remains fixed and the blades 124 rotate around the hub 122. In some embodiments, the rotor 120 is driven by an electric motor. In some embodiments, the rotor 120 is driven by a wet fuel engine. In some embodiments, the rotor 120 is connected to the airfoil 110 by a mounting bracket 128. In some embodiments, the mounting bracket 128 is secured to the upper surface 119 of the airfoil 110, as shown in FIG. 1. In some embodiments, the mounting bracket 128 is secured to the lower surface 117 of the airfoil. The mounting bracket 128 preferably has an aerodynamic contour such that the mounting bracket 128 minimizes interference with airflow over the surfaces of the airfoil 110.

As shown in FIG. 2, the rotor 120 is positioned a first distance D1 behind the trailing edge 114 of the airfoil 110, as measured along the longitudinal axis L, and a second distance D2 substantially vertically below the lower surface 117 of the airfoil 110. In some embodiments, the first distance D1 and the second distance D2 are measured relative to a quarter chord point CH of the airfoil 110 and the center point CP of the rotor 120. The quarter chord point CH is positioned on a chord C measured between the leading edge 112 and the trailing edge 114 of the airfoil 110. In some embodiments, the quarter chord point CH is positioned on the chord C closer to the leading edge 112 than the trailing edge 114. In some embodiments, the quarter chord point CH is located on the chord C a distance from the leading edge 112 that is one-quarter of the chord C. In some embodiments, the quarter chord point CH is positioned on the chord C closer to the trailing edge 114 than the leading edge 112. In some embodiments, the quarter chord point CH is located on the chord C a distance from the trailing edge 114 that is one-quarter of the chord C. In some embodiments, the first distance D1 is about two times the radial distance R (2R). In some embodiments, the second distance D2 is about 0.7 times the radial distance R (0.7R). In some embodiments, the first distance D1 is such that the positioning of the rotor 120 results in a longitudinal overlap D3 of the airfoil 110 and the rotor 120. In some embodiments, the longitudinal overlap D3 is measured between the trailing edge 114 of the airfoil 110 and a distal end 126 of the blades 124 (also referred to herein as the blade-tip 126) of the rotor 120, as shown in FIG. 2. In some embodiments, the longitudinal overlap D3 is less than 0.125 times the radial distance R (0.125R).

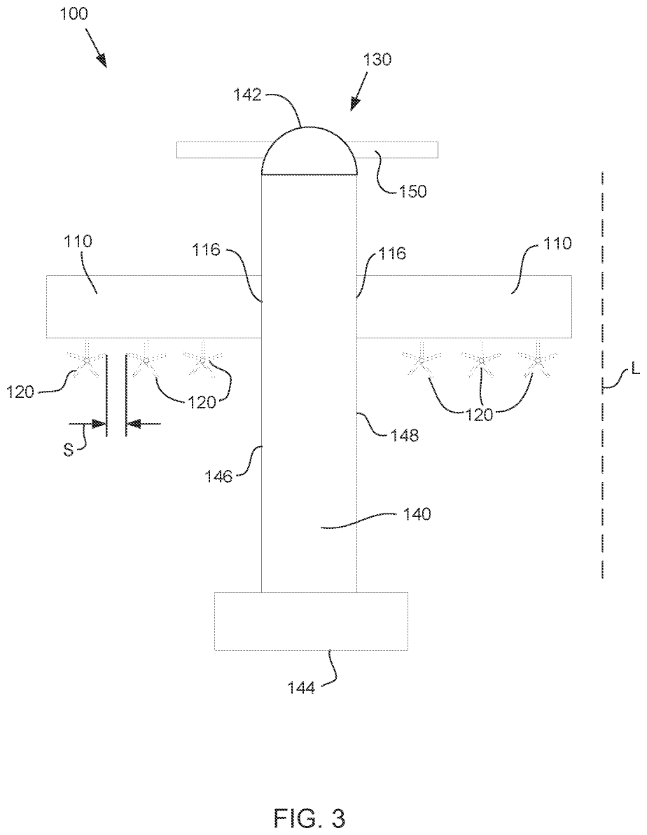

In some embodiments, the system 100 includes a plurality of rotors 120, each of which are positioned the first distance D1 and the second distance D2 from the airfoil 110, as discussed above. As shown in FIG. 3, the plurality of rotors 120 are adjacent one another along the length L1 of the airfoil 110. Each of the plurality of rotors 120 is separated from each respective adjacent rotor 120 by a blade-tip to blade-tip spacing S. In some embodiments, the blade-tip to blade-tip spacing S is about 0.25 times the radial distance R (0.25R). In some embodiments, the number of rotors 120 of the plurality of rotors 120 is related to the length L1 of the airfoil 110 using L1=2×Nᵣ×R+Nᵣ×S, where Nᵣ equals the number of rotors 120, R is the radial distance discussed herein, and S is the blade-tip to blade-tip spacing discussed herein.

In some embodiments, the system 100 includes an aircraft 130 having a fuselage 140, as shown in FIG. 3. The fuselage 140 has a front end 142 and a tail end 144 that are generally aligned with the longitudinal axis L of the system 100. The fuselage 140 has a first lateral side 146 and a second lateral side 148 opposite the first lateral side 146. The proximal end 116 of a first airfoil 110 is connected to the first lateral side 146 of the fuselage 140, and the proximal end 116 of a second airfoil 110 is connected to the second lateral side 148 of the fuselage 140. A first plurality of rotors 120 are positioned behind and below the first airfoil 110 and arranged along the length L1 of the first airfoil 110, as discussed above. A second plurality of rotors 120 are positioned behind and below the second airfoil 110 and arranged along the length L1 of the second airfoil 110, as discussed above. In some embodiments, each of the rotors 120 are connected to the respective airfoil 110 by a mounting bracket 128, as discussed above. In some embodiments, the first plurality of rotors 120 is connected to the fuselage 140 by a first support frame and the second plurality of rotors 120 is connected to the fuselage 140 by a second support frame. In some embodiments, the aircraft 130 includes a propeller 150 connected to the front end 142 of the fuselage 140. In some embodiments, the propeller 150 is driven by a wet fuel engine. In some embodiments, the propeller 150 is driven by an electric motor.

Accordingly, exemplary embodiments of the present technology are directed to an aircraft lift enhancement system having a lifting rotor mounted below and behind the wing of an aircraft, which results in additional suction over the upper surface of the wing. The rotor-induced suction over the upper surface of the wing increases wing lift by up to 134%, and this phenomenon increases at higher values of rotor disk loading. As the rotor disk loading increases, the rotor induced suction over the upper surface of the wing also increases, thereby increasing the wing lift coefficient by about 0.13 for each additional pound-per-square-foot (lb/ft²) of disk loading. The inventors have surprisingly discovered that this added suction near the leading edge of the wing counters the nominal wing drag and introduces a net propulsive force, which increases at higher wing incidence angles and higher rotor disk loading. In some embodiments, the wing-induced downwash on the rotor introduces a thrust deficit of up to 10% and a torque penalty of up to 4% from nominal. Despite these rotor performance penalties, the increased wing lift and reduced wing drag resulting from the rotor-induced suction increases the lift-to-drag ratio by up to 49% as compared to the wing without the rotor interactions.

As will be apparent to those skilled in the art, various modifications, adaptations, and variations of the foregoing specific disclosure can be made without departing from the scope of the technology claimed herein. The various features and elements of the technology described herein may be combined in a manner different than the specific examples described or claimed herein without departing from the scope of the technology. In other words, any element or feature may be combined with any other element or feature in different embodiments, unless there is an obvious or inherent incompatibility between the two, or it is specifically excluded.

References in the specification to “one embodiment,” “an embodiment,” etc., indicate that the embodiment described may include a particular aspect, feature, structure, or characteristic, but not every embodiment necessarily includes that aspect, feature, structure, or characteristic. Moreover, such phrases may, but do not necessarily, refer to the same embodiment referred to in other portions of the specification. Further, when a particular aspect, feature, structure, or characteristic is described in connection with an embodiment, it is within the knowledge of one skilled in the art to affect or connect such aspect, feature, structure, or characteristic with other embodiments, whether or not explicitly described.

The singular forms “a,” “an,” and “the” include plural reference unless the context clearly dictates otherwise. Thus, for example, a reference to “a plant” includes a plurality of such plants. It is further noted that the claims may be drafted to exclude any optional element. As such, this statement is intended to serve as antecedent basis for the use of exclusive terminology, such as “solely,” “only,” and the like, in connection with the recitation of claim elements or use of a “negative” limitation. The terms “preferably,” “preferred,” “prefer,” “optionally,” “may,” and similar terms are used to indicate that an item, condition, or step being referred to is an optional (not required) feature of the technology.

The term “and/or” means any one of the items, any combination of the items, or all of the items with which this term is associated. The phrase “one or more” is readily understood by one of skill in the art, particularly when read in context of its usage.

Each numerical or measured value in this specification is modified by the term “about.” The term “about” can refer to a variation of ±5%, ±10%, ±20%, or ±25% of the value specified. For example, “about 50” percent can in some embodiments carry a variation from 45 to 55 percent. For integer ranges, the term “about” can include one or two integers greater than and/or less than a recited integer at each end of the range. Unless indicated otherwise herein, the term “about” is intended to include values and ranges proximate to the recited range that are equivalent in terms of the functionality of the composition, or the embodiment.

As will be understood by one skilled in the art, for any and all purposes, particularly in terms of providing a written description, all ranges recited herein also encompass any and all possible sub-ranges and combinations of sub-ranges thereof, as well as the individual values making up the range, particularly integer values. A recited range (e.g., weight percents of carbon groups) includes each specific value, integer, decimal, or identity within the range. Any listed range can be easily recognized as sufficiently describing and enabling the same range being broken down into at least equal halves, thirds, quarters, fifths, or tenths. As a non-limiting example, each range discussed herein can be readily broken down into a lower third, middle third, and upper third, etc.

As will also be understood by one skilled in the art, all language such as “up to,” “at least,” “greater than,” “less than,” “more than,” “or more,” and the like, include the number recited and such terms refer to ranges that can be subsequently broken down into sub-ranges as discussed above. In the same manner, all ratios recited herein also include all sub-ratios falling within the broader ratio. Accordingly, specific values recited for radicals, substituents, and ranges, are for illustration only; they do not exclude other defined values or other values within defined ranges for radicals and substituents.

One skilled in the art will also readily recognize that where members are grouped together in a common manner, such as in a Markush group, the technology encompasses not only the entire group listed as a whole, but each member of the group individually and all possible subgroups of the main group. Additionally, for all purposes, the technology encompasses not only the main group, but also the main group absent one or more of the group members. The technology therefore envisages the explicit exclusion of any one or more of members of a recited group. Accordingly, provisos may apply to any of the disclosed categories or embodiments whereby any one or more of the recited elements, species, or embodiments, may be excluded from such categories or embodiments, for example, as used in an explicit negative limitation.

1. An aircraft lift enhancement system comprising:
an airfoil having a leading edge and a trailing edge defining a longitudinal axis of the airfoil, and a proximal end and a distal end defining a length of the airfoil; and
at least one rotor positioned a first distance D1 substantially behind the trailing edge of the airfoil as measured along the longitudinal axis and a second distance D2 substantially vertically below a lower surface of the airfoil, the at least one rotor comprising a hub and a plurality of aerodynamic blades extending outwards from the hub a radial distance R and configured to rotate in a substantially horizontal plane around a center point CP of the rotor.

2. The system of claim 1, wherein the first distance D1 and the second distance D2 are measured relative to a quarter chord point CH of the airfoil, the quarter chord point CH is positioned on a chord measured between the leading edge and the trailing edge.

3. The system of claim 2, wherein the first distance D1 is about 2 times the radial distance R.

4. The system of claim 2, wherein the second distance D2 is about 0.7 times the radial distance R.

5. The system of claim 1, wherein the first distance D1 is such that the positioning of the at least one rotor results in a longitudinal overlap of the trailing edge of the airfoil and the at least one rotor of less than 0.125 times the radial distance R.

6. The system of claim 1, wherein the at least one rotor comprises a plurality of rotors positioned the first distance D1 and the second distance D2 from the airfoil and adjacent one another along the length of the airfoil.

7. The system of claim 6, wherein each of the plurality of rotors is separated from each respective adjacent rotor by a blade-tip to blade-tip spacing of about 0.25 times the radial distance R.

8. The system of claim 1, wherein the airfoil has an asymmetrical shape.

9. The system of claim 1, wherein the at least one rotor is driven by an electric motor.

10. The system of claim 1, wherein the at least one rotor is driven by a wet fuel engine.

11. The system of claim 1, wherein the proximal end of the airfoil is connected to a fuselage of an aircraft.

12. The system of claim 1, wherein the at least one rotor is connected to the airfoil via a mounting bracket.

13. An aircraft comprising:
a fuselage having a front end and a tail end defining a longitudinal axis of the aircraft, a first lateral side, and a second lateral side opposite the first lateral side;
a first airfoil having a first leading edge and a first trailing edge substantially aligned with the longitudinal axis of the aircraft, and a first proximal end and a first distal end defining a length of the airfoil, the first proximal end is connected to the first lateral side of the fuselage;
a second airfoil having a second leading edge and a second trailing edge substantially aligned with the longitudinal axis of the aircraft, and a second proximal end and a second distal end defining a length of the airfoil, the second proximal end is connected to the second lateral side of the fuselage;
at least one first rotor positioned a first distance D1 substantially behind the first trailing edge of the first airfoil as measured along the longitudinal axis and a second distance D2 substantially vertically below a first lower surface of the first airfoil; and
at least one second rotor positioned the first distance D1 substantially behind the second trailing edge of the second airfoil as measured along the longitudinal axis and the second distance D2 substantially vertically below a second lower surface of the second airfoil;
each of the at least one first rotor and the at least one second rotor comprising a hub and a plurality of aerodynamic blades extending outwards from the hub a radial distance R and configured to rotate in a substantially horizontal plane around a center point CP of the rotor.

14. The aircraft of claim 13, wherein the first distance D1 and the second distance D2 are measured relative to a first quarter chord point CH1 of the first airfoil and a second quarter chord point CH2 of the second airfoil, the first quarter chord point CH1 is positioned on a chord measured between the first leading edge and the first trailing edge, and the second quarter chord point CH2 is positioned on a chord measured between the second leading edge and the second trailing edge.

15. The aircraft of claim 13, wherein the first distance D1 is about 2 times the radial distance R.

16. The aircraft of claim 13, wherein the second distance D2 is about 0.7 times the radial distance R.

17. The aircraft of claim 13, wherein the first distance D1 is such that the positioning of each of the at least one first rotor and at least one second rotor results in a longitudinal overlap of the trailing edge of the respective airfoil and the respective rotor of less than 0.125 times the radial distance R.

18. The aircraft of claim 13, wherein the at least one first rotor comprises a plurality of first rotors positioned the first distance D1 and the second distance D2 from the first airfoil and adjacent one another along the length of the first airfoil, and the at least one second rotor comprises a plurality of second rotors positioned the first distance D1 and the second distance D2 from the second airfoil and adjacent one another along the length of the second airfoil.

19. The aircraft of claim 18, wherein each of the plurality of first rotors and the plurality of second rotors is separated from each respective adjacent rotor by a blade-tip to blade-tip spacing of about 0.25 times the radial distance R.

20. The aircraft of claim 13, wherein each of the first airfoil and the second airfoil has an asymmetrical shape.

21. The aircraft of claim 13, wherein each of the at least one first rotor and the at least one second rotor is driven by a respective electric motor.

22. The aircraft of claim 13, wherein each of the at least one first rotor and the at least one second rotor is driven by a respective wet fuel engine.

23. The aircraft of claim 13, wherein the at least one first rotor is connected to the first airfoil via a first mounting bracket and the at least one second rotor is connected to the second airfoil via a second mounting bracket.
